(19) United States
(12) Patent Application Publication
(10) Pub. No.: US 2007/0051569 A1
(43) Pub. Date: Mar. 8, 2007

(54) Brake system for vehicle

(75) Inventors: Kyosuke Kitayama, Saitama (JP); Hisashi Kadomatsu, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/514,178

(22) Filed: Sep. 1, 2006

(30) Foreign Application Priority Data
Sep. 5, 2005 (JP) 2005-256213

(51) Int. Cl. B62L 3/00

(52) U.S. Cl. 188/76; 188/24.11

(57) ABSTRACT

To provide a brake system for a vehicle by which enhancement of brake performance is achieved and the heat generated due to braking can be efficiently cooled. A rotor is formed in a substantially annular shape with frictional surfaces being provided at an inner circumferential surface and an outer circumferential surface. The rotor is disposed in the wheel width direction so as to project out in the width direction relative to a rim of the wheel. A caliper is disposed so that the inner circumferential surface and the outer circumferential surface of the rotor are clamped by pads.

### CROSS-REFERENCE TO RELATED APPLICATIONS

The present application claims priority under 35 USC 119 to Japanese Patent Application No. 2005-256213 filed on Sep. 5, 2005 the entire contents of which are hereby incorporated by reference.

### BACKGROUND OF THE INVENTION

1. Field of the Invention

The present invention relates to a brake system for a vehicle.

2. Description of Background Art

A brake system for a vehicle is known wherein a braking force is obtained by clamping a rotor, fixed to a wheel, between a pair of pads mounted on a caliper.

Referring to the brake system for a vehicle in more detail, a substantially circular disk-shaped rotor is fixed to the wheel, and the caliper is disposed on the vehicle in such a manner that both side surfaces of the rotor are clamped by the pair of pads in a horizontal direction.

Such a brake system for a vehicle is generally of the type in which the rotor is clamped by the pads from the outside of the rotor. In addition, another type of brake system is available wherein which the rotor is fixed to the rim side of the wheel and is held by the pads from the inside of the rotor. According to the latter type of brake system for a vehicle, it is said, the average diameter of the frictional surface can be enlarged without lowering the natural frequency of the disk rotor, so that the press contact force per brake pad can be reduced while keeping the brake performance as it is, with the result that the brake noise can be reduced. See, for example, Japanese Patent Laid-Open No. 2002-48162, Page 2, FIG. 1.

In general, enhancement of brake performance can be expected by clamping the rotor at a position spaced away as much as possible outwards in a wheel radial direction from a central portion of the wheel. However, in any one of the above-mentioned brake systems for a vehicle, the frictional surface (the surface clamped between the pad) of the rotor is in a wheel radial direction, so that the systems are enlarged in size.

### SUMMARY AND OBJECTS OF THE INVENTION

Accordingly, it is an object of an embodiment of the present invention, made in consideration of the above circumstances, to provide a brake system for a vehicle by which the above-mentioned problem can be solved.

In order to solve the above-mentioned technical problems, a brake system for a vehicle according to the present invention has taken the following measures.

The brake system according to an embodiment of the present invention resides in a brake system for a vehicle, operative to obtain a braking force by clamping a rotor between a pair of pads provided at a caliper, wherein the rotor is in a substantially annular shape provided with frictional surfaces at an inner circumferential surface and an outer circumferential surface thereof. The rotor is fixed to a wheel of the vehicle and the caliper is fixed to the vehicle side so that the pads clamp the inner circumferential surface and the outer circumferential surface of the rotor.

The brake system according to an embodiment of the present invention provides the rotor to be disposed on the outside in the width direction relative to a rim of the wheel, or to project out in the width direction relative to the rim of the wheel.

The brake system according to an embodiment of the present invention provides the rotor that is fixed through an annular attachment fixed to a side surface of the wheel.

The brake system according to an embodiment of the present invention provides the caliper to be an opposite type caliper in which pistons for respectively operating the pair of pads are disposed opposite to each other.

The brake system according to an embodiment of the present invention provides the caliper to be disposed on the front side or the rear side of the rotor.

The brake system according to an embodiment of the present invention provides the caliper to be disposed on the inside of a fork supporting the wheel so as to overlap with the fork as viewed from the rear side.

A brake fixation for a vehicle according to an embodiment of the present invention provides a method of fixing a brake system for a vehicle, the brake system being operative to obtain a braking force by clamping a rotor between a pair of pads provided at a caliper, wherein the rotor is in a substantially annular shape provided with frictional surfaces at an inner circumferential surface and an outer circumferential surface thereof and the rotor is fixed to a wheel of the vehicle, and the caliper is fixed to the vehicle side so that the pads clamp the inner circumferential surface and the outer circumferential surface of the rotor.

According to according to an embodiment of the present invention, the rotor is in a substantially annular shape and is provided with friction surfaces at an inner circumferential surface and an outer circumferential surface thereof. The inner circumferential surface and the outer circumferential surface of the rotor are clamped by the pads, whereby the rotor can be clamped at a position spaced away by as much as possible outwards from the central portion of the wheel. Therefore, enhancement of the brake performance can be contrived.

In addition, the rotor is disposed on the outside in the width direction relative to the rim of the wheel, and the rotor is disposed so as to project out in the width direction relative to the rim of the wheel, to ensure that the during operation of the vehicle the airflow makes direct contact with the frictional surfaces. Therefore, the rotor, where heat is generated due to braking, can be cooled efficiently.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a motorcycle in which a brake system for a vehicle according to the present embodiment is mounted;

FIG. 2 is a partly cut-out front view of a front wheel portion;

FIG. 3 is a front view showing a bottom case, a caliper, and a rotor in a picked-up state;

FIG. 4 is an enlarged perspective view of a part of the front wheel portion;

FIG. 5 is a cross sectional plan view of a rear wheel portion;

FIG. 6 is a perspective view showing a caliper and a rotor in a picked-up state;

FIG. 7 is an enlarged perspective view of a part of the rear wheel portion;

FIG. 8 is a side view of a caliper fixing arm with a caliper bridgingly mounted thereon;

FIG. 9 is a plan view of the caliper fixing arm with the caliper bridgingly mounted thereon; and

FIG. 10 is a perspective view of the caliper fixing arm with the caliper bridgingly mounted thereon.

### DETAILED DESCRIPTION OF THE PREFERRED EMBODIMENTS

Now, an embodiment of the brake system for a vehicle according to the present invention will be described below.

As the brake system for a vehicle in this embodiment, one that is applied to a motorcycle is shown as an example, and a detailed description of the configuration of parts other than the brake systems constituting an essential part will be omitted. As illustrated in the figures a motorcycle A and a brake system 8 are provided.

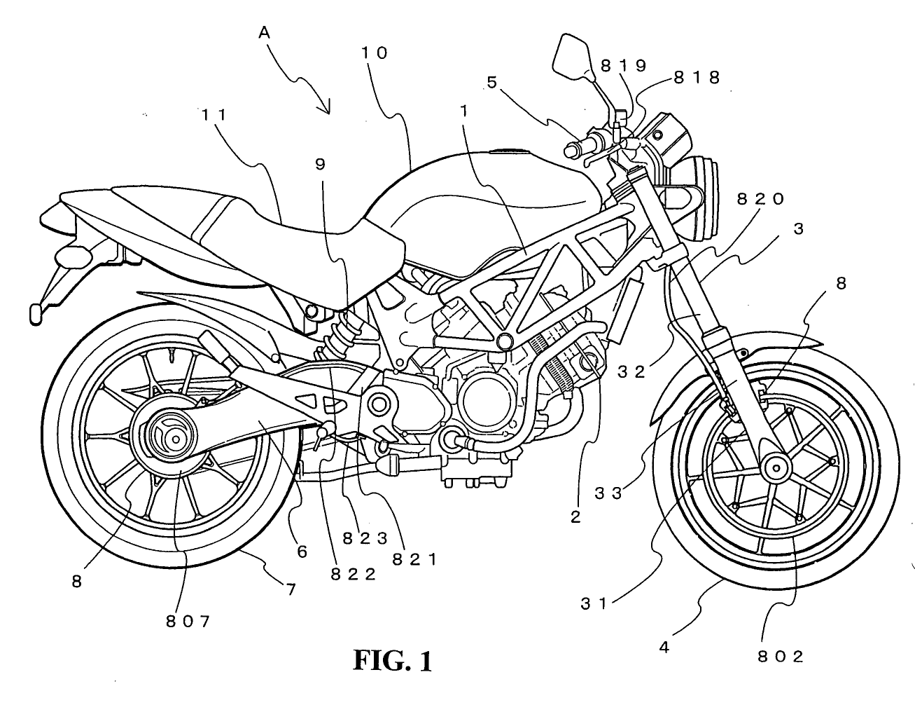

As shown in FIG. 1, the motorcycle A in which the brake system for a vehicle according to this embodiment is mounted includes a vehicle body frame 1, an engine 2 supported on the vehicle body frame 1, a left-right pair of forks 3 having bottom case portions 31 at its lower portions and mounted on the front side of the vehicle body frame 1, a front wheel portion 4 supported on lower portions of the forks 3 and a steering bar handle 5 supported on an upper portion of the forks 3. A swing arm 6 is vertically swingably supported on a roughly middle lower portion of the vehicle body frame 1 and is roughly an angular U-shaped in plan view, a rear wheel portion 7 supported on the swing arm 6 and brake systems 8 are provided for braking the front and rear wheels. A rear suspension 9 is bridgingly arranged so as to connect the vehicle body frame 1 and the swing arm 6 to each other. A fuel tank 10 is fixed on the front side of an upper portion of the vehicle body frame 1, and a seat 11 is provided adjacently to the fuel tank 10. The motorcycle A is operated by an individual controlling the steering bar handle operations, throttle operations, gear operations and the like.

The brake systems 8 constitutes an essential part of the present invention will be described in detail below, separately for the front wheel portion 4 and for the rear wheel portion 7.

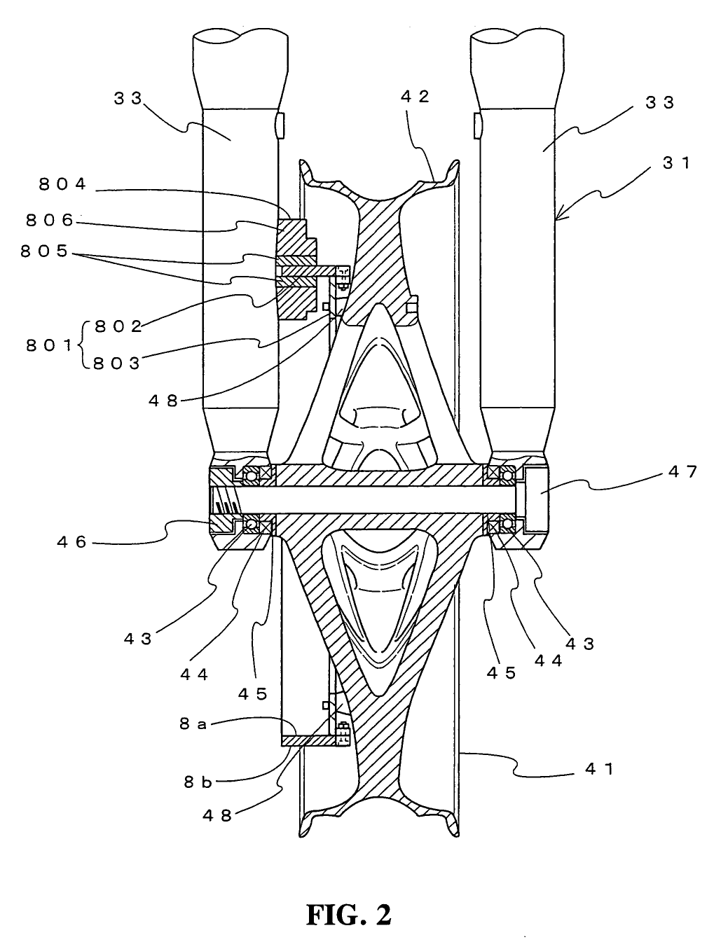

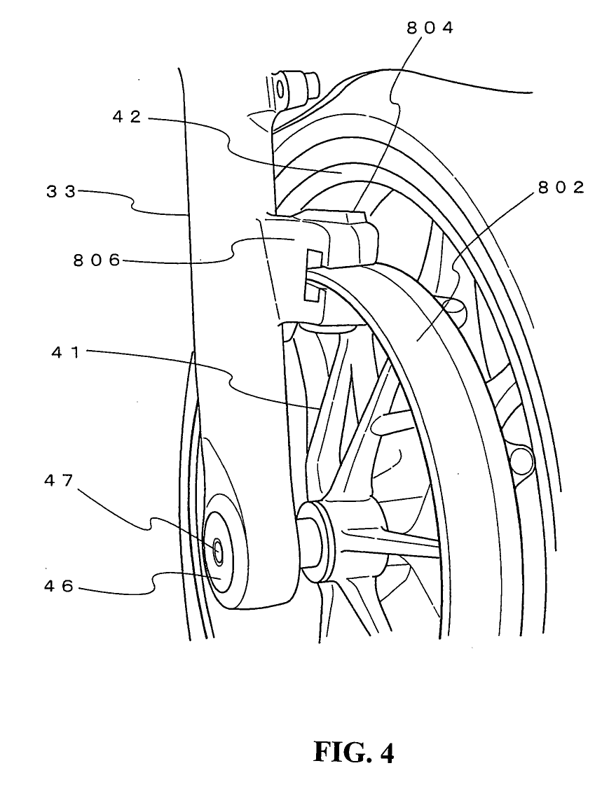

As shown in FIGS. 2 to 4, the brake system 8 for the front wheel portion 4 includes a front wheel side rotor portion 801, and the bottom case portions 31.

The front wheel side rotor portion 801 includes a rotor 802 and an attaching ring 803 (attachment).

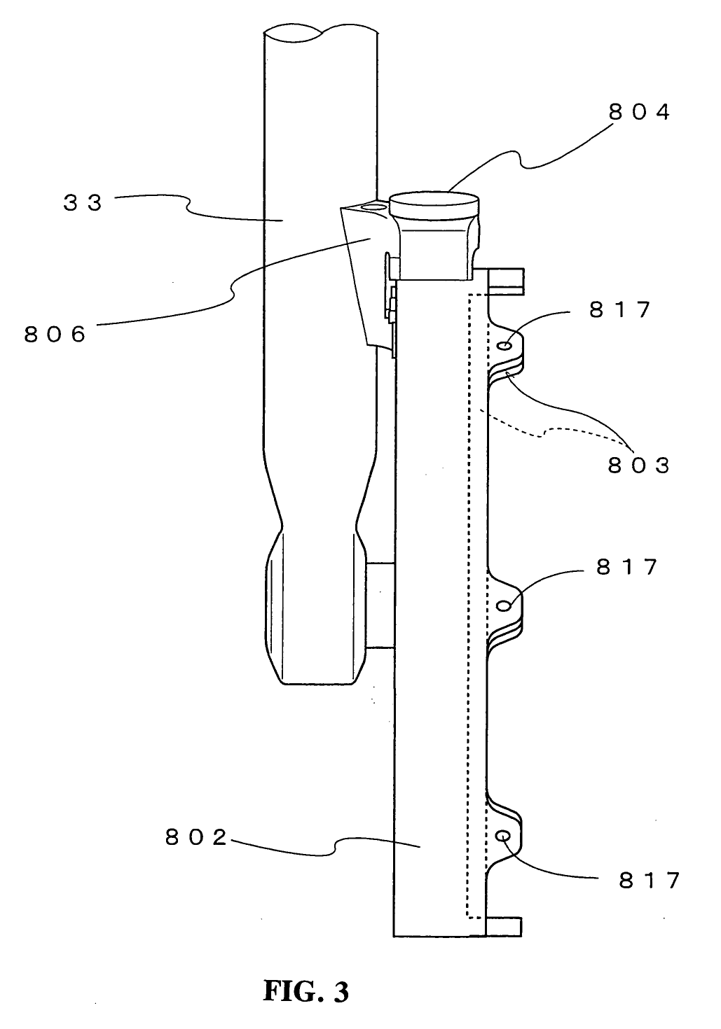

The rotor 802 is formed in a substantially annular shape (substantially tubular shape) having a required width and provided with frictional surfaces at an inner circumferential surface 8a and an outer circumferential surface 8b thereof. One side surface (on the side of a front wheel side wheel 41) is stretched in a substantially projecting shape at a required interval along the circumferential direction. In addition, as shown in FIG. 3, each of the stretched portions is provided with a counterbore 817 for screw engagement with the attaching ring 803 which will be described later.

The attaching ring 803 is formed in a substantially annular shape for obviating interference with the front wheel side wheel 41, and portions of an outer circumferential portion thereof are stretched in a substantially projecting shape at a required interval along the circumferential direction so as to correspond to the stretched portions of the rotor 802. Furthermore, the substantially projecting stretched portions are provided with screw holes corresponding to the counterbores 817 formed in the rotor 802.

The attaching ring 803 is screwed to a boss 48 projecting from a side surface of the front wheel side wheel 41, the screw holes provided in the attaching ring 803 and the counterbores 817 are connected by bolt-nut pairs, and the rotor 802 is fixed to the attaching ring 803 fixed to the front wheel side wheel 41, in such a manner that an end portion on one side of the rotor 802 projects out in the width direction relative to the rim 42 of the front wheel side wheel 41.

The rotor 802 and the attaching ring 803 are configured as separate members in this embodiment, but they may be configured as an integral body.

The bottom case portions 31 include bottom cases 33 composed of constituent members of the substantially hollow cylindrical forks 3 through which to pass a pair of fork pipes 32, and a caliper 804 provided on the inside of the bottom case 33 on one side.

The caliper 804 is composed of an opposite type caliper in which pistons (not shown) for respectively operating a pair of pads 805 are disposed opposite to each other. The caliper 804 is disposed on the inside of the bottom case 33 supporting the front wheel side wheel 41 and in such a manner that it overlaps with the bottom case 33 as viewed sideways and that the pads 805 clamp the inner circumferential surface 8a and the outer circumferential surface 8b of the rotor 802.

In addition, as shown in FIG. 1, the caliper 804 is in conjunction with a brake lever 818 provided on the steering bar handle 5, through a master cylinder 819 for generating an oil pressure and a brake hose 820, so that the inner and outer circumferential surfaces 8a and 8b of the rotor 802 are clamped by an operation of the brake lever 818.

The pair of forks 3 having the bottom cases 33 are supported on the vehicle body frame 1 so that their upper portion side is inclined toward the vehicle rear side. Thus, the caliper 804 is disposed on the rear side relative to the rotor 802.

Furthermore, as for the engagement between the caliper 804 and the bottom case 33, a caliper body 806 constituting the caliper 804 is extremely preferably formed as one body with the bottom case 33, as shown in FIG. 1. However, a configuration may be adopted in which an attaching portion is stretchedly formed on the bottom case 33 side, and the caliper 804 is screwed or riveted to the attaching portion.

In addition, as for the engagement between the front wheel side wheel 41 and the bottom case 33, a configuration is adopted in which the front wheel side wheel 47 is turnably disposed between support portions each including the bottom case 33, a bearing 43, a seal 44, a collar 45 and a nut 46, and the front wheel side wheel 41 and the front wheel side axle 47 are fixed by fitting to each other so that the front wheel side wheel 41 and the front wheel side axle 47 are turned (turned together).

In addition, while the position of the rotor 802 is located at an intermediate portion of the front wheel side wheel 41 in FIG. 2, the rotor 802 is preferably disposed at a position spaced away by as much as possible outwards from a central portion of the front wheel side wheel 41. In addition, while the caliper 804 is shown to be entering into the inside of the front wheel side wheel 41, the width of the rotor 802 may be enlarged so that the caliper 804 does not enter into the inside of the front wheel side wheel 41. In this case, the rotor 802 can be laid out at a position spaced further outwards from the central portion of the wheel.

In the brake system 8 for the front wheel portion 4 configured as above, the frictional surfaces (the surfaces to be clamped by the pads 805) of the rotor 802 are present in the wheel width direction, so that the rotor 802 can be disposed more on the outer circumferential side of the front wheel side wheel 41, whereby a braking force can be obtained more easily and the whole system can be reduced in weight, as compared to a conventional brake system in which the frictional surfaces of the rotor 802 are present in the wheel radial direction.

In addition, since the rotor 802 is disposed to project out in the width direction relative to the wheel rim 42 so that an operating airflow will easily come into contact with the rotor 802, the heat generated due to braking can be easily dispersed. Moreover, since the caliper 804 is disposed so as not to readily obstruct the flow of the running airflow coming into contact with the rotor 802, the running airflow will easily come into contact with the rotor 802, whereby the cooling performance for the rotor 802 is enhanced.

Further, in the case where the engagement between the attaching ring 803 and the front wheel side wheel 41 and the engagement between the attaching ring 803 and the rotor 802 are conducted by use of bolts, it is necessary to provide the front wheel side wheel 41 with attaching holes directed in the axial direction of the wheel, and to provide the rotor 802 with attaching holes directed in the radial direction; however, these directions permit easy boring, so that these component parts can be easily formed at the time of manufacturing.

In addition, with the opposite type caliper adopted, there is no need for providing a groove and a mechanism portion which are needed for sliding the caliper body 806 in the case of a floating type caliper. Thus, the system can be simplified in structure.

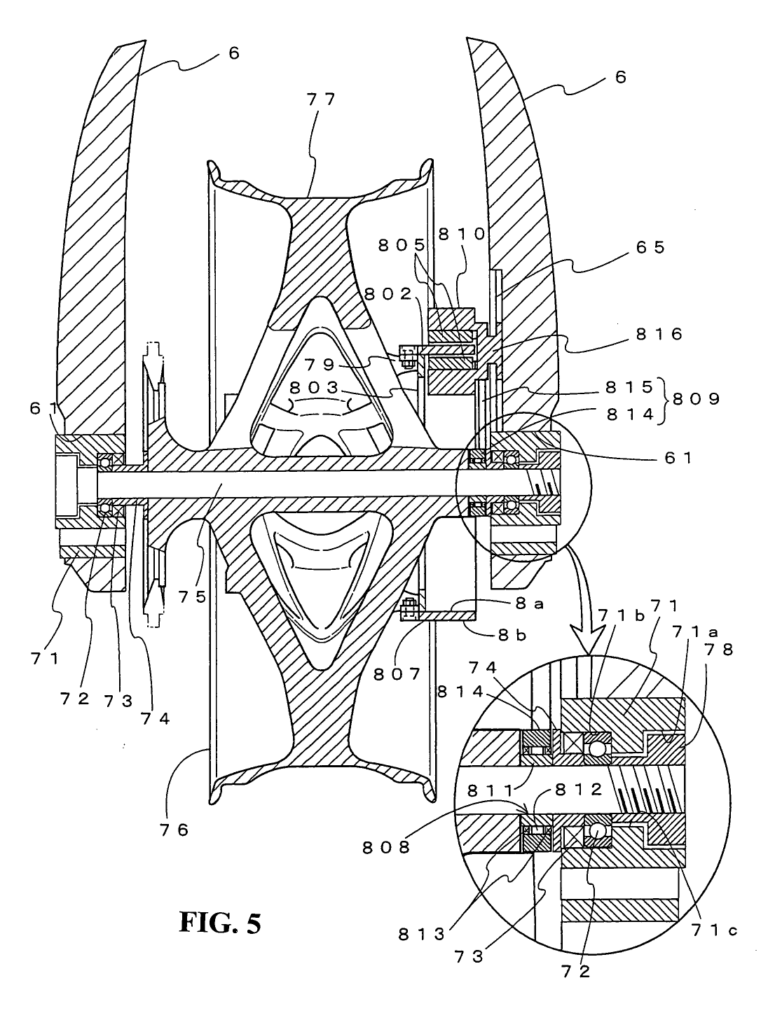

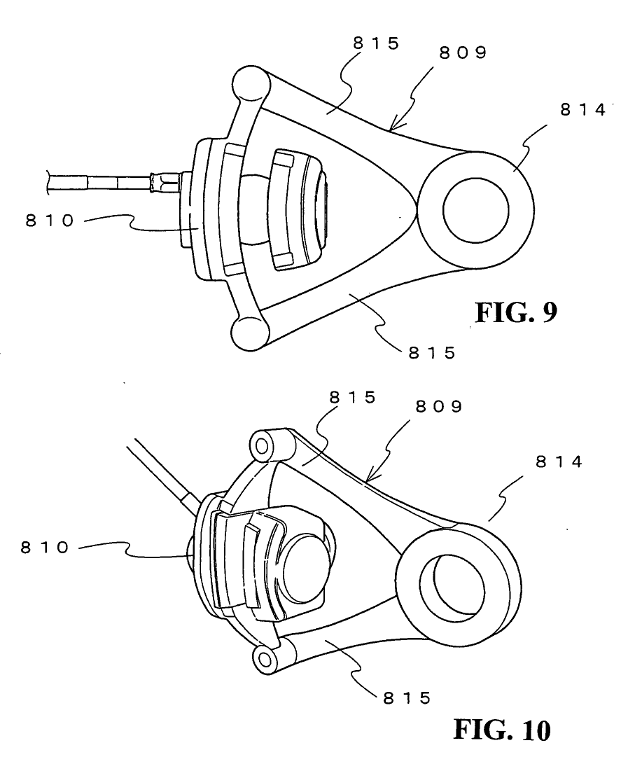

Now, the brake system 8 for the rear wheel portion 7 will be described below referring to FIGS. 5 to 10. In the description of the brake system 8 for the rear wheel portion 7, the structure around the rear wheel will be also described, for convenience.

The structure around the rear wheel is configured to include the swing arm 6, bearing support members 71, bearings 72, seals 73, collars 74, and the brake system 8 for the rear wheel portion 7.

The swing arm 6 is vertically swingably supported on a roughly middle lower portion of the vehicle body frame 1, and is roughly an angular U-shaped in plan view. Of the swing arm 6, end portions on the vehicle rear side are provided with support holes 61 in which the hearing support members 71 (described later) are fitted and which communicate with each other in the vehicle width direction.

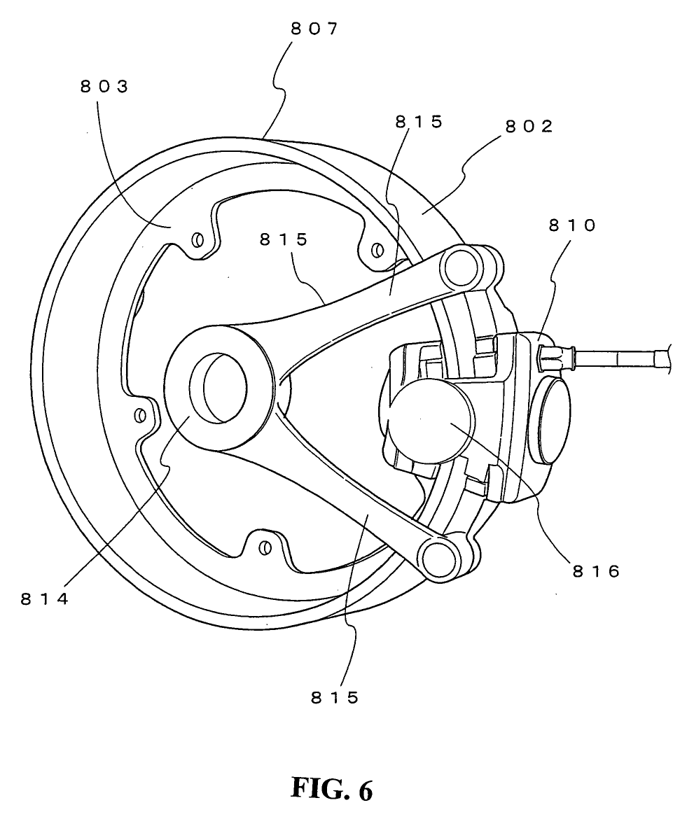

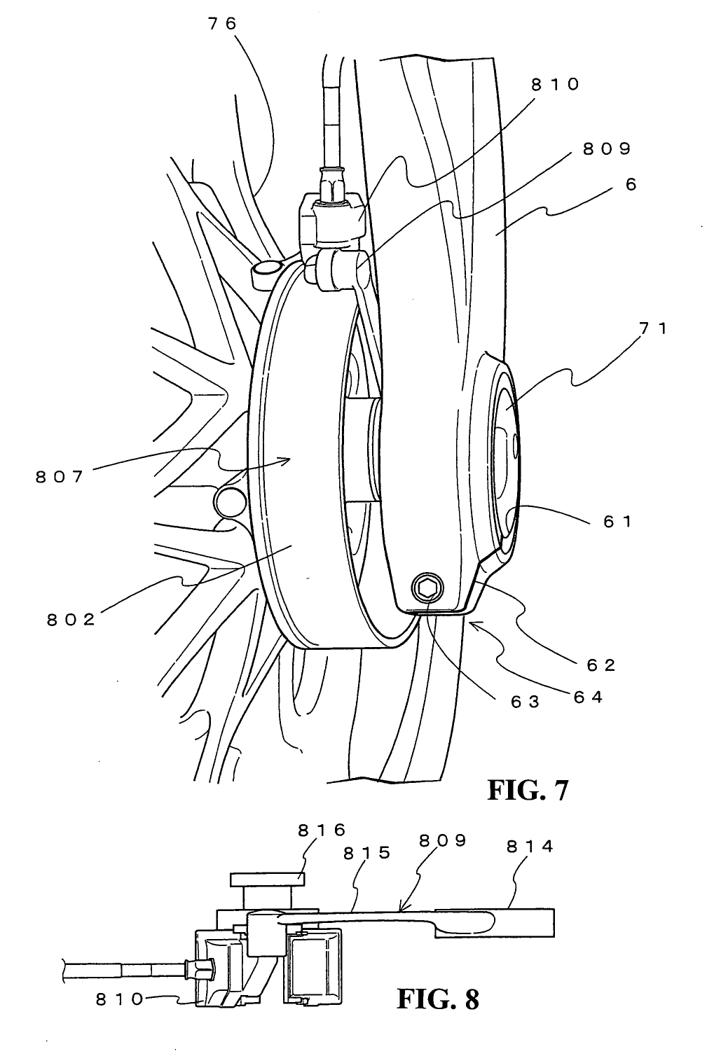

Furthermore, a slot 62 penetrating through the support hole 61 and the outside surface of the swing arm 6 is provided. The outside surface of the swing arm 6 in the vicinity of the slot 62 is provided with projecting form fastening portions on both sides of the slot 62, and a bolt 63 is screwed in the fastening portions orthogonally to the slot 62, whereby a slot clamp 64 is formed as shown in FIG. 7.

The slot clamp 64 as described above is so configured that, by fastening the bolt 63, the support hole 61 is reduced in diameter to clamp the bearing support member 71.

In addition, on the inside on a rear wheel side rotor portion 807 side of the swing arm 6, a dovetail groove 65 communicating with the support hole 61 is provided to extend over a required length along the longitudinal direction of the swing arm 6.

The bearing support member 71 is formed in the shape of a substantially cylindrical column provided on its outside with a counterbore portion 71a which is formed as a bottomed hole with a required diameter and in which to seat a head portion of the rear wheel side axle 75, provided on its inside with a bearing fitting portion 71b which is formed as a bottomed hole with a required diameter, and provided with a communication hole 71c for communication between the counterbore portion 71a and the bearing fitting portion 71b. The counterbore portion 71a, the bearing fitting portion 71b and the communication hole 71c are provided rectilinearly at a position deviated by a required amount from the center of the substantially cylindrical column. The bearing support member 71 thus configured is fitted in each support hole 61, with the counterbore portion 71a on the outside.

The bearing 72 is a rolling bearing such as a ball bearing and a needle bearing, and is fitted in each bearing fitting portion 71b.

The seal 73 is formed in a substantially annular form, and is fitted in each bearing fitting portion 71b to be adjacent to the bearing 72, so as to prevent dust, water drops or the like from entering into the bearing 72.

The collar 74 is formed in a hollow annular shape which is substantially like a projection in sectional view, and is fitted in each bearing fitting portion so as to bias an inner ring of the bearing 72 from the inside, through the seal 73 therebetween. The collar 74 is turned together with the rear wheel side axle 75, which is in the shape of a stepped shaft.

The brake system 8 for the rear wheel portion 7 as an essential part of the present invention includes the rear wheel side rotor portion 807, a needle bearing portion 808, a caliper fixing arm 809, and a caliper 810.

The rear wheel side rotor portion 807 has the same configuration as that of the front wheel side rotor portion 801 described above. More specifically, the rear wheel side rotor portion 807 is the same as the front wheel side rotor portion, except that it includes a rotor 802 and an attaching ring 803 (attachment), the attaching ring 803 is screw engaged with a boss 79 provided projectingly from a side surface of the rear wheel side wheel 76, and a frictional surface is disposed on the outside in the width direction relative to a rim 77 of the rear wheel side wheel 76.

The needle bearing portion 808 is formed in a substantially hollow cylindrical shape, and includes a second collar 811 fitted to the rear wheel side axle 75 between the collar 74 and the rear wheel side wheel 76, a needle bearing 812 fitted on the outer circumference of the second collar 811, and annular second seals 813 fitted on the outer sides of both ends of the needle bearing 812 so as to prevent dust, water drops or the like from entering into the needle bearing 812.

The caliper fixing arm 809 includes an annular base portion 814 turnably supported by the rear wheel side axle 75 through the needle bearing 812 and the second seals 813, and a roughly V-shaped arm 815 extended in a bifurcated form from the base portion 814, and the caliper 810 (described later) is bridgingly disposed between tip portions of the roughly V shape.

The caliper fixing arm 809 is disposed between a side surface of a central portion of the wheel and the collar 74 at required intervals.

The caliper 810 is composed of an opposite type caliper in which pistons (not shown) for respectively operating a pair of pads 805 are disposed opposite to each other, and a back surface (on the opposite side of the rotor 807 side) of the caliper 810 is provided with a boss 816 which is roughly T-shaped in side view and slidably engaged with the dovetail groove 65.

As described above, the caliper 810 is bridgingly disposed between the tip portions of the roughly V shape of the caliper fixing arm 809, and is so disposed that it is located on the inside of the swing arm 6 supporting the rear wheel side wheel 76, so that it overlaps with the swing arm 6 as viewed sideways, and that the pads 805 clamp the inner circumferential surface 8a and the outer circumferential surface 8b of the rotor 807. Therefore, the caliper 810 on the rear wheel side is disposed on the front side relative to the center of the rotor 807.

In addition, as shown in FIG. 1, the caliper 810 is in conjunction with a foot pedal 823 through a master cylinder 821 for generating an oil pressure and a brake hose 822 is so configured that by operation of the foot pedal 823, the inner and outer circumferential surfaces 8a and 8b of the rotor 807 are clamped under the oil pressure.

Furthermore, as for the engagement between the rear wheel side wheel 76 and the swing arm 6, the rear wheel side axle 75 in the shape of a stepped shaft is turnably disposed through the bearings 72 between support members each including the swing arm 6, the bearing support member 71, the bearing 72, the seal 73, the collar 74, the brake device 8 for the rear wheel portion 7, and a nut 78. The rear wheel side wheel 76 and the rear wheel side axle 75 are fixed by being fitted to each other to permit rotation of a rear wheel tire and the rear wheel side axle 75.

In the brake system 8 for the rear wheel portion 7 thus configured, the frictional surfaces (the surfaces to be clamped by the pads 805) of the rotor 807 are present in the wheel width direction, in the same manner as in the case of the front wheel portion 4. Therefore, the rotor 807 can be disposed more on the outer circumferencial side of the rear wheel side wheel, whereby a braking force can be obtained more easily and the whole system can be reduced in weight, as compared to a conventional brake system in which the frictional surfaces of the rotor 807 are present in the wheel radial direction.

In addition, it may come to be necessary to adjust the position of the rear wheel tire by displacing the position of the rear wheel side axle 75 rearwards according to an elongation of a drive chain meshed with a sprocket. In such a case, first, the bolts 63 at the slot clamps 64 are untightened, and the bearing support members 71 are turned by a desired angle.

In this instance, since the counterbore portion 71a and the bearing fitting portion 71b and the communication hole 71c are provided rectilinearly at a position deviated by a required amount from the center of the bearing support member 71, the rear wheel side axle 75 supported by the bearing support members 71 is moved in the front-rear direction, and the rear wheel tire is moved in the front-rear direction. At the same time, as for the caliper 810, the boss 816 provided on the back side of the caliper 810 is slid in the front-rear direction, with the dovetail groove 65 formed in the swing arm 6 as a guide.

Next, after the rear wheel tire is located at a desired position, the position is fixed by tightening the bolts 63 at the slot clamps 64, whereby adjustment of the position of the rear wheel tire in the front-rear direction is finished.

Thus, the brake system 8 for the rear wheel portion 7 is made to cope with the adjustment of the position of the rear wheel tire in the front-rear direction.

In addition, the rotor 807 in the rear wheel portion 7 is arranged so that the frictional surfaces are located on the outside in the width direction relative to the rim 77 of the rear wheel side wheel 76, to permit the operating air flow to easily come into contact with the rotor 807. Therefore, the heat generated due to braking can be dispersed easily, like in the case of the front wheel portion 4. Moreover, since the caliper 810 is disposed at such a position as not to easily obstruct the flow of the operating air flow coming into contact with the rotor 807, it is ensured that the operating air flow will easily come into contact with the rotor 807, whereby the cooling performance for the rotor 807 is enhanced.

In addition, for the rotor 807 in the rear wheel portion 7, the configuration in which attaching rings are omitted is shown as an example. According to such a configuration, the number of component parts is reduced, whereby manufacturing cost, assembly cost and the like can be suppressed to be low.

Further, like in the case of the front wheel portion 4, the opposite type caliper is adopted, so that it is unnecessary to provide a groove and a mechanism portion for sliding a caliper body, which are needed in the case of a floating type caliper. Thus, the system can be simplified in structure.

While the brake systems according to this embodiment have been described above, the above embodiment is merely an example of a preferred mode for carrying out the present invention. The present invention is not limited to the embodiment, and various modifications are possible within the scope of the gist of the invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A brake system for a vehicle, operative to obtain a braking force by clamping a rotor between a pair of pads provided at a caliper, comprising:
a substantially annular shape rotor being provided with frictional surfaces at an inner circumferential surface and an outer circumferential surface thereof, said rotor being fixed to a wheel of said vehicle; and
said caliper is fixed to the vehicle side so that said pads clamp said inner circumferential surface and said outer circumferential surface of said rotor.

2. The brake system for the vehicle as set forth in claim 1, wherein said rotor is disposed on the outside in a width direction relative to a rim of said wheel, or is disposed so as to project out in the width direction relative to said rim of said wheel.

3. The brake system for the vehicle as set forth in claim 1, wherein said rotor is fixed through an annular attachment fixed to a side surface of said wheel.

4. The brake system for the vehicle as set forth in claim 2, wherein said rotor is fixed through an annular attachment fixed to a side surface of said wheel.

5. The brake system for the vehicle as set forth in claim 1, wherein said caliper is an opposite type caliper in which pistons for respectively operating said pair of pads are disposed opposite to each other.

6. The brake system for the vehicle as set forth in claim 2, wherein said caliper is an opposite type caliper in which pistons for respectively operating said pair of pads are disposed opposite to each other.

7. The brake system for the vehicle as set forth in claim 3, wherein said caliper is an opposite type caliper in which pistons for respectively operating said pair of pads are disposed opposite to each other.

8. The brake system for the vehicle as set forth in claim 1, wherein said caliper is disposed on the front side or the rear side of said rotor.

9. The brake system for the vehicle as set forth in claim 2, wherein said caliper is disposed on the front side or the rear side of said rotor.

10. The brake system for the vehicle as set forth in claim 3, wherein said caliper is disposed on the front side or the rear side of said rotor.

11. The brake system for the vehicle as set forth in claim 5, wherein said caliper is disposed on the front side or the rear side of said rotor.

12. The brake system for the vehicle as set forth in claim 1, wherein said caliper is disposed on the inside of a fork supporting said wheel so as to overlap with said fork as viewed from the side.

13. The brake system for the vehicle as set forth in claim 2, wherein said caliper is disposed on the inside of a fork supporting said wheel so as to overlap with said fork as viewed from the side.

14. The brake system for the vehicle as set forth in claim 3, wherein said caliper is disposed on the inside of a fork supporting said wheel so as to overlap with said fork as viewed from the side.

15. The brake system for the vehicle as set forth in claim 5, wherein said caliper is disposed on the inside of a fork supporting said wheel so as to overlap with said fork as viewed from the side.

16. The brake system for the vehicle as set forth in claim 8, wherein said caliper is disposed on the inside of a fork supporting said wheel so as to overlap with said fork as viewed from the side.

17. A method of fixing a brake system for a vehicle, said brake system being operative to obtain a braking force by clamping a rotor between a pair of pads provided at a caliper, comprising the following steps:
providing said rotor formed in a substantially annular shape with frictional surfaces at an inner circumferential surface and an outer circumferential surface thereof; and
fixing said rotor to a wheel of said vehicle wherein said caliper is fixed to the vehicle side so that said pads clamp said inner circumferential surface and said outer circumferential surface of said rotor.

18. A brake system for providing a braking force comprising:
a substantially annular shaped rotor having frictional surfaces at an inner circumferential surface and an outer circumferential surface thereof, said rotor being adapted to a secured to a wheel; and
a caliper adapted to be mounted adjacent to said substantially annular shaped rotor pads clamp, said caliper including a first pad adapted for engaging said inner circumferential surface and a second pad adapted for engaging said outer circumferential surface of said rotor for providing a braking force.

19. The brake system for providing a braking force as set forth in claim 18, wherein said rotor is disposed on the outside in a width direction relative to a rim of a wheel, or is disposed so as to project out in the width direction relative to a rim of a wheel.

20. The brake system for providing a braking force as set forth in claim 18, wherein said rotor is fixed through an annular attachment fixed to a side surface of a wheel.
